(19) United States
(12) Patent Application Publication
(10) Pub. No.: US 2026/0002439 A1
(43) Pub. Date: Jan. 1, 2026

(54) TWO DIMENSIONAL PROCESSING FOR MULTIPLE NESTED STRING VARIABLE THICKNESS PROFILE EVALUATION USING MULTIFREQUENCY NON-COLLOCATED INDUCTION MEASUREMENTS

(71) Applicant: SCHLUMBERGER TECHNOLOGY CORPORATION, Sugar Land, TX (US)

(72) Inventors: Saad OMAR, Cambridge, MA (US); Dzevat OMERAGIC, Lexington, KY (US)

(21) Appl. No.: 19/119,830

(22) PCT Filed: Nov. 17, 2023
(86) PCT No.: PCT/US2023/080334

§ 371 Date: Apr. 10, 2025

Related U.S. Application Data
(60) Provisional application No. 63/384,189, filed on Nov. 17, 2022.

(51) Int. Cl. E21B 47/13; E21B 47/00; G01V 3/28

(52) U.S. Cl. CPC E21B 47/13; E21B 47/006; G01V 3/28

(57) ABSTRACT

Systems and methods to determine a thickness profile of nested metallic pipes can include processing long sections (windows) of induction multi spacing and multi frequency noncollocated sensor measurements (attenuation and phase). The systems and methods also include using an inversion based process to deconvolve the tool transfer function from the surrounding pipe structure and its anomalies by running an axisymmetric finite element method (FEM modeling solver with a model in an inversion loop.

### CROSS-REFERENCE TO RELATED APPLICATION

This application claims priority to and the benefit of U.S. Provisional Patent Application Ser. No. 63/384,189, entitled “2D PROCESSING FOR MULTIPLE NESTED STRING VARIABLE THICKNESS PROFILE EVALUATION USING MULTIFREQUENCY NON-COLLOCATED INDUCTION MEASUREMENTS,” filed Nov. 17, 2022, which is hereby incorporated by reference in its entirety for all purposes.

### FIELD OF THE INVENTION

The present disclosure generally relates to processing of multi-spacing and multi-frequency measurements to alleviate double indication of casing collar and corrosion defects.

### BACKGROUND INFORMATION

There are traditional methods of multi-frequency, multi-spacing tool measurements and data processing in the context of multi-casing corrosion analysis that have been used. For example, certain processing methods include using target data acquisition with methods that invert measurements already addressed by one-dimensional (radial) modeling and inversion. Other processing methods use multi-stage processing to match the measurements with a dictionary of “delta-like” responses from each casing using linear systems of equations to estimate defects in each pipe. At k^{th} stage, kₜₕ casing delta-like responses are used to match the corrected responses from (k-1) casing defects. The output is an image-like description of the defects in the casings. However, none of these traditional methods provide processing that uses general non-linear numerical inversion that can be used to determine thickness profiles along the depth of multiple nested metallic pipes using long data intervals, thereby, eliminating ghost effects.

### SUMMARY

A summary of certain embodiments described herein is set forth below. It should be understood that these aspects are presented merely to provide the reader with a brief summary of these certain embodiments and that these aspects are not intended to limit the scope of this disclosure.

In one example embodiment, a method to determine a thickness profile of nested metallic casings includes processing induction multi-spacing and multi-frequency non-collocated sensor data measured by a downhole well tool disposed proximate a plurality of nested metallic casings. The sensor data is received from one or more transmitters and one or more receivers oriented arbitrarily in space. The method also includes using an inversion-based process to deconvolve a tool transfer function from a surrounding casing structure and its anomalies by running an axisymmetric modeling solver with a model in an inversion loop. The method further includes determining a thickness profile of the plurality of nested metallic casings based at least in part on the deconvolved tool transfer function.

In another example embodiment, a tangible computer-readable medium includes computer instructions that, when executed by at least on processor, cause the at least one processor to process induction multi-spacing and multi-frequency non-collocated sensor data measured by a downhole well tool disposed proximate a plurality of nested metallic casings. The sensor data is received from one or more transmitters and one or more receivers oriented arbitrarily in space. The computer instructions, when executed by the at least on processor, also cause the at least one processor to use an inversion-based process to deconvolve a tool transfer function from a surrounding casing structure and its anomalies by running an axisymmetric FEM modeling solver with a model in an inversion loop. The computer instructions, when executed by the at least on processor, further cause the at least one processor to determine a thickness profile of the plurality of nested metallic casings based at least in part on the deconvolved tool transfer function.

In yet another example embodiment, a downhole well tool is configured to measure and process induction multi-spacing and multi-frequency non-collocated sensor data received from one or more transmitters and one or more receivers oriented arbitrarily in space. The downhole well tool is also configured to use an inversion-based process to deconvolve a tool transfer function from a surrounding casing structure and its anomalies by running an axisymmetric FEM modeling solver with a model in an inversion loop. The downhole well tool is further configured to determine a thickness profile of a plurality of nested metallic casings based at least in part on the deconvolved tool transfer function.

### BRIEF DESCRIPTION OF THE DRAWINGS

Various aspects of this disclosure may be better understood upon reading the following detailed description and upon reference to the drawings, in which:

FIG. 1 depicts a schematic diagram of a system for measuring tubular thickness using a downhole electromagnetic (EM) logging tool, in accordance with embodiments of the present disclosure;

FIG. 2 depicts a schematic diagram of at least a portion of an example implementation of an EM logging tool, in accordance with embodiments of the present disclosure;

FIG. 3 depicts a schematic diagram of an example implementation of the EM logging tool shown in FIG. 2, in accordance with embodiments of the present disclosure;

FIG. 4 depicts a schematic diagram of another example implementation of the EM logging tool shown in FIG. 2, in accordance with embodiments of the present disclosure;

FIG. 5 depicts non-collocated sensitivities over 40 feet (typical pipe joint length) with each pipe collar 10 feet apart from inner pipe's collar, with the non-collocation results in double indication; first, when the transmitter crosses the collar, and second, when the receiver crosses it, in accordance with embodiments of the present disclosure;

FIG. 6 depicts an example workflow for inversion based multi-casing thickness profile evaluation, in accordance with embodiments of the present disclosure;

FIG. 7 depicts an embodiment of a sliding window strategy for processing intervals of data, in accordance with embodiments of the present disclosure;

FIG. 8 depicts inversion results for four-casing (OD: 4.5″, 7″, 9⅝″, 13⅜″) comparing the inversion results with truth, in accordance with embodiments of the present disclosure;

FIG. 9 depicts reconstructed data in the 9^{th} window (48-60 feet) of profile-based inversion, in accordance with embodiments of the present disclosure;

FIG. 10 depicts pixel-based inversion results, in accordance with embodiments of the present disclosure;

FIG. 11 depicts an example of re-segmentation of original log-squaring segments based on quality of 1D model data-fit, in accordance with embodiments of the present disclosure;

FIG. 12 depicts results of a four-casing (OD: 4.5″, 7″, 9⅝″, and 13⅜″) processing results for hybrid (pixelated model) inversion, in accordance with embodiments of the present disclosure;

FIG. 13 depicts results for the same true profile but in terms of four different cases, in accordance with embodiments of the present disclosure; and

FIG. 14 shows a comparison of sequential and multi-pass parallelized sliding window processing results from inverting data for three casings (OD: 8⅝″, 13⅜″, and 18⅝″; Δnom: 0.264″, 0.33″, and 0.435″) where the first casing is maximally eccentered with respect to the tool axis, in accordance with embodiments of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the data processing system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

Similarly, as used herein, the term “substantially parallel” may be used to define downhole tools, formation layers, and so forth, that have longitudinal axes that are parallel with each other, only deviating from true parallel by a few degrees of each other. For example, a downhole tool that is substantially parallel with a formation layer may be a downhole tool that traverses the formation layer parallel to a boundary of the formation layer, only deviating from true parallel relative to the boundary of the formation layer by less than 5 degrees, less than 3 degrees, less than 2 degrees, less than 1 degree, or even less.

The embodiments described herein provide a multi-casing inspection tool that uses multi-frequency non-collocated (multi spacing) sensors. In certain embodiments, the transmitter may be excited by a time-domain pulse and a series of continuous wave (CW) multifrequency excitations. The time-domain pulse excitation may also suffice to record non-collocated responses that can electronically be converted into multi-frequency (harmonics) measurements. However, the decreasing signal-to-noise ratio of higher harmonics due to the inverse scaling with frequency, may be addressed by CW excitation where each frequency is excited individually to achieve maximum signal-to-noise ratio. The total metal loss may be evaluated from a look-up table of measured attenuation or phase, where the receiver voltage may be normalized to a signal from a monitor coil wound around the transmitter. All of these measurements and interpretations may be based on remote field eddy current (RFEC) principle, where the phase of the induced signal is proportional to total casing thickness if the receiver is sufficiently far from the transmitter.

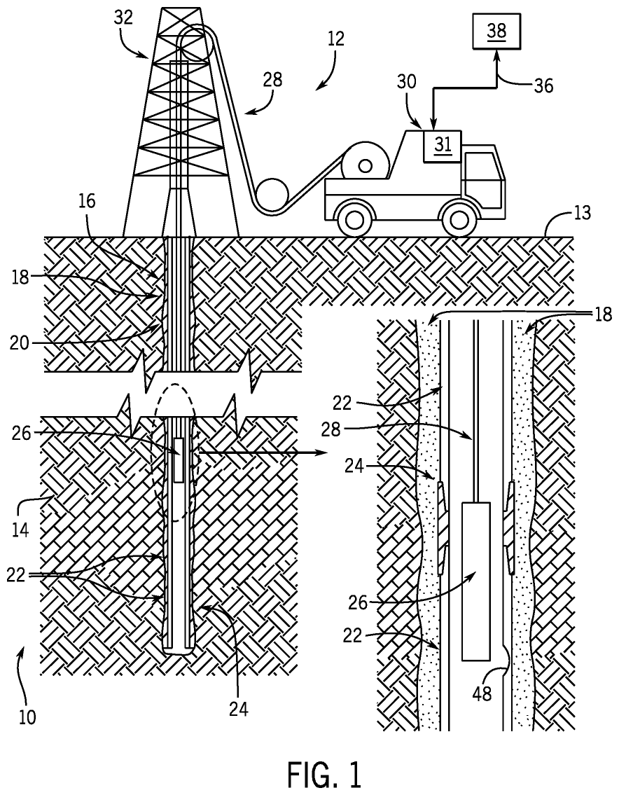

With the foregoing in mind, FIG. 1 depicts a schematic diagram of a system 10 for measuring tubular thickness using a downhole electromagnetic EM logging tool 26 according to one or more aspects of the present disclosure. Surface equipment 12 is located on a wellsite surface 13 above a geological formation 14 into which a wellbore 16 extends from the wellsite surface 13. An annular fill 18 has been used to seal an annulus 20 between the wellbore 16 and tubulars (e.g., casings) 22, such as via cementing operations. The EM logging tool 26 may be centered or decentered, such that a measuring and/or detecting device (e.g., a transmitter or a receiver) of the EM logging tool 26 is positioned centrally or off-center relative to a central longitudinal axis of the tubulars 22.

The tubulars 22 may be coupled together by collars 24. The tubulars 22 represent lengths of pipe including threads and/or other means for connecting each end to threads and/or other connection means of an adjacent collar 24 and/or tubular 22. Each tubular 22 and/or collar 24 may be made of steel and/or other electrically conductive materials able to withstand a variety of forces, such as collapse, burst, and tensile failure, as well as chemically-aggressive fluid. Each tubular 22 and/or collar 24 may have magnetic properties and be affected by an alternating EM current.

The surface equipment 12 may carry out various well-logging operations to detect conditions (e.g., thicknesses) of the tubulars 22, including implementations in which the tubulars 22 are concentrically nested, as shown in FIGS. 3 and 4. The well-logging operations may measure individual and/or cumulative thicknesses of the tubulars 22 by using the EM logging tool 26.

The EM logging tool 26 may be conveyed within the wellbore 16 by a cable 28. Such cable 28 may include one or more mechanical cables, electrical cables, and/or electro-optical cables that include one or more fiber-optic lines protected against the harsh environment of the wellbore 16. In certain embodiments, the EM logging tool 26 may be conveyed using other conveyance means, such as coiled tubing or a tractor.

The EM logging tool 26 may generate a time-varying magnetic field signal that interacts with the tubulars 22. The EM logging tool 26 may be energized from the surface (e.g., via the cable 28) or have its own internal power used to emit the time-varying magnetic field signal via one or more EM sources (e.g., transmitters). The time-varying magnetic field signal may travel outward from the EM logging tool 26 through and along the tubulars 22. The time-varying magnetic field signal may generate eddy currents in the tubulars 22, which produce corresponding returning magnetic field signals measured as magnetic field anomalies by one or more receivers (e.g., sensors) in the EM logging tool 26. Each measurement may be denoted as a remote field eddy current (RFEC) if a source-receiver spacing is substantially longer (e.g., longer than approximately 2.5 times an outer diameter of the tubular 22 being inspected). At a defect 48 in the tubulars 22, such as the defect caused by metal gain or loss to the tubulars 22, the returning magnetic field signals may arrive at the EM logging tool 26 with a change in phase and/or signal strength (e.g., amplitude) induced by the defect 48, relative to other returning magnetic field signals not interacting with (e.g., passing through) the defect 48. In some cases, combined measurements (e.g., at far-field with RFEC, near-field, or transition zone) of multiple receivers may be used to create a data log and determine individual and/or cumulative thicknesses of the tubulars 22 using EM and/or other suitable field-testing analyses.

The EM logging tool 26 may be deployed inside the wellbore 16 by the surface equipment 12, which may include a vehicle 30 and a deploying system such as a drilling rig, workover rig, platform, derrick, and/or other surface structure 32. Data (e.g., log data) related to the tubulars 22 gathered by the EM logging tool 26 may be transmitted to the surface and/or stored in the EM logging tool 26 for later processing and analysis. The vehicle 30 may be fitted with and/or communicate with a data processing system 38 via a communication component 31 to perform data collection and analysis. When the EM logging tool 26 provides measurements to the surface equipment 12 (e.g., through the cable 28), the surface equipment 12 may pass the measurements as EM tubular evaluation data 36 to a data processing system 38.

The data processing system 38 may obtain the measurements from the EM logging tool 26 as raw data. In certain embodiments, the measurements may be processed or pre-processed by the EM logging tool 26 before being sent to the data processing system 38. Processing of the measurements may incorporate using and/or obtaining other measurements, such as from ultrasonic, caliper, and/or other EM logging techniques to better constrain unknown parameters of the tubulars 22. Accordingly, the data processing system 38 and/or the EM logging tool 26 may be utilized in acquiring additional information about the tubulars 22 and/or the wellbore 16, such as a number of tubulars 22, nominal thickness of each tubular 22, centering of the tubulars 22 relative to the wellbore 16, centering of the EM logging tool 26 within the wellbore 16, electromagnetic and/or ultrasonic properties of the tubulars 22, ambient and/or wellbore temperature, caliper measurements, and/or other parameters that may be utilized during thickness analyses of the tubulars 22.

In certain embodiments, the data processing system 38 may include one or more processor(s), memory, storage, and communication circuitry, among other data processing components. The processor(s) may be any type of computer processor or microprocessor capable of executing computer-executable code. The processor(s) may include single-threaded processor(s), multi-threaded processor(s), or both. The processor(s) may also include hardware-based processor(s) each including one or more cores. The processor(s) may include general purpose processor(s), special purpose processor(s), or both. The processor(s) may be communicatively coupled to other internal components (such as the memory and the storage). The memory and the storage may be any suitable articles of manufacture that can serve as media to store processor-executable code, data, or the like. These articles of manufacture may represent computer-readable media (e.g., any suitable form of memory or storage) that may store the processor-executable code used by the processor(s) to perform the presently disclosed techniques. The memory and the storage may also be used to store data described herein, various other software applications for data analysis and data processing. The memory and the storage may represent non-transitory computer-readable media (e.g., any suitable form of memory or storage) that may store the processor-executable code used by the processor(s) to perform various techniques described herein. It should be noted that non-transitory merely indicates that the media is tangible and not a signal. In addition, in certain embodiments, the EM logging tool 26 may also include data processing components similar to the data processing system 38 such that the EM logging tool 26 may be configured to perform at least a portion of the data processing functions described herein.

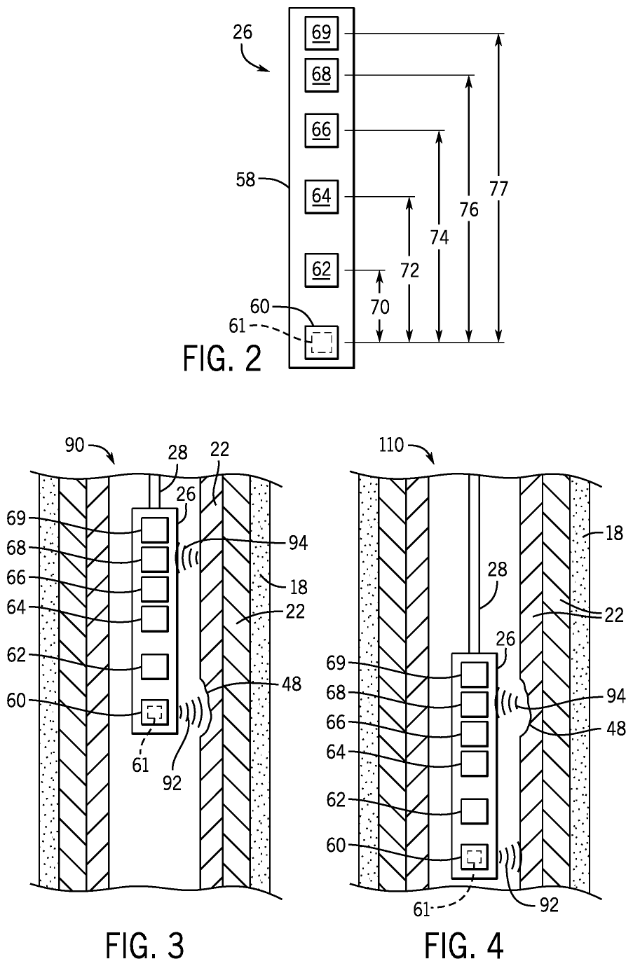

FIG. 2 depicts a schematic diagram of at least a portion of an example implementation of the EM logging tool 26 that may be utilized for casing and other tubular inspection within the scope of the present disclosure. The EM logging tool 26 may include a transmitter 60, one or more collocated receivers 61, and one or more non-collocated receivers (e.g., receivers 62, 64, 66, 68, and 69). The transmitter 60, the one or more collocated receivers 61, and the one or more non-collocated receivers 62, 64, 66, 68, 69 may be enclosed within or otherwise carried with a housing 58. The housing 58 may be a pressure-resistant housing.

The receivers 62, 64, 66, 68, and 69 may be operated based on various magnetic field detection techniques, such as coiled-winding, Hall-effect sensor, giant magneto-resistive sensor, and/or other magnetic field measuring means. The receivers 62, 64, 66, 68, and 69 may be axially aligned within the EM logging tool 26, as depicted in the example implementation shown in FIG. 2. In certain embodiments, or one or more of the receivers 62, 64, 66, 68, and 69 may be radially or transversely offset along an axis (e.g., longitudinal axis) of the EM logging tool 26. For example, the one or more of the receivers 62, 64, 66, 68, and 69 may be azimuthally offset towards or adjacent a perimeter of the EM logging tool 26. In such embodiments, multiple receivers distributed azimuthally may permit generating a two-dimensional image of properties (e.g., thickness) of the tubulars 22. Embodiments within the scope of the present disclosure may also include implementations using multiple transmitters, in which windings of the multiple transmitters are transverse or oblique, as in a saddle coil arrangement, which couple to the receivers or additional receiver windings.

In the example implementation shown in FIG. 2, the one or more collocated receivers 61 are located at the same location as the transmitter 60 (at zero distance from the transmitter 60), and the receivers 62, 64, 66, 68, and 69 are located at different distances away from the transmitter 60. For example, the receiver 62 may be located a distance 70 from the transmitter 60, the receiver 64 may be located a distance 72 from the transmitter 60, the receiver 66 may be located a distance 74 from the transmitter 60, the receiver 68 may located a distance 76 from the transmitter 60, and the receiver 69 may located a distance 77 from the transmitter 60. The distances 72, 74, 76, and 77 may each be a multiple of the distance 70. For example, the distance 72 may be twice the distance 70. In certain embodiments, the receivers 62, 64, 66, 68, and 69 may be located at distances of between 0 inches to 120 inches or more from the transmitter 60.

The receivers 62, 64, 66, 68, and 69 may detect a strength (e.g., signal amplitude) and/or a phase of the returning magnetic field from the tubulars 22. The EM logging tool 26 and/or the data processing system 38 may use detected values (e.g., amplitude and/or phase values) to create a data log. Based on the data log, the EM logging tool 26 and/or the data processing system 38 may determine individual and/or cumulative thicknesses of the tubulars 22 utilizing various EM and/or other suitable field-testing analyses. For example, by minimizing a norm of the difference (e.g., using a least-squares minimization) between the observed data (e.g., the data log) and synthetic data (e.g., simulated data log from a numerical modeling), the EM logging tool 26 and/or the data processing system 38 may determine best-fit parameters for a model (e.g., a digital representation) of the tubulars 22. Various techniques, such as inversion, model searching, and simulated annealing may be used to interpret the data log.

FIG. 3 depicts a schematic diagram of an example implementation of the EM logging tool 26 shown in FIG. 2. The example implementation includes a system 90 for measuring thickness of the tubulars 22. As the EM logging tool 26 descends through the tubulars 22, the transmitter 60 generates a time-varying magnetic field 92 that interacts with the tubulars 22 made by certain conductive materials. The time-varying magnetic field 92 travels outward from the transmitter 60 and then through and along the tubulars 22. The time-varying magnetic field 92 generates eddy currents in the tubulars 22, which produce corresponding returning magnetic field 94. The returning magnetic field 94 propagates to the receivers 62, 64, 66, 68, and 69, which detect the returning magnetic field 94 and convert detected portions of the returning magnetic field 94 into corresponding signals. As the transmitter 60 passes by the defect 48, a portion of the returning magnetic field 94 may arrive at the receiver 68 with a shift of phase and/or a change in strength (e.g., signal amplitude) relative to when the transmitter 60 is not passing by the defect 48, as depicted in FIG. 4 below.

FIG. 4 depicts a schematic diagram of another example implementation of the EM logging tool 26 shown in FIG. 2. The example implementation includes a system 110 for measuring thickness of tubulars 22. As the EM logging tool 26 travels further downhole within the tubulars 22, the receiver 68 passes by the defect 48, as shown in FIG. 4. The returning magnetic field 94 may arrive at the receiver 68 with a different phase shift and/or change in strength (e.g., signal amplitude) relative to when the transmitter 60 is passing by the defect 48, as depicted in FIG. 3 above. Thus, the defect 48 may be detected twice (as a “ghost”) by the combination of the transmitter 60 and the receiver 68, including a first time when the transmitter 60 passes by the defect 48, and a second time when the receiver 68 passes by the defect 48. In certain embodiments, different combinations, such as the transmitter 60 and one of the other receivers 62, 64, 66, and 69, may detect similar “ghosts” as the transmitters 60 and then the corresponding receiver passes by the defect 48, respectively. Such phenomenon (e.g., “ghost”) may also be observed at the collars 24 due to their increase of metal thickness when coupled to the tubulars 22, and also at other completion components in a well.

In certain embodiments, the EM logging tool 26 may include one or more transmitter coils with one or more collocated receivers wrapped on top of transmitter and/or one or more non-collocated receiver subs. For instance, one receiver (e.g., receiver 68) may detect multiple returning magnetic fields (e.g., returning magnetic field 98) excited by time-variant (e.g., decayed) eddy currents in multiple casings of the tubulars 22 and generate a set of time-domain collocated data. In some embodiments, two or more receivers may be situated at the same location and detect one or more returning magnetic fields excited by the time-variant eddy currents in one or more casings of the multiple casings of the tubulars 22 and generate a second set of time-domain collocated data. In some embodiments, multiple receivers situated at different locations may detect different multiple returning magnetic fields (e.g., arriving at different receiver locations) excited by the time-variant eddy currents in the multiple casings of the tubulars 22 and generate a set of multi-frequency, multi-spacing non-collocated data. The quantity of the one or more non-collocated receiver subs may be any number, such as one, three, ten, or the like. The one or more non-collocated receiver subs may include any number of non-collocated receivers. For example, a first non-collocated receiver sub may include one receiver, a second non-collocated receiver sub may include two receivers, a third non-collocated receiver sub may include 3 receivers, and a fourth non-collocated receiver sub may include 4 receivers.

In certain embodiments, the transmitters 60 may be excited by a time-domain pulse excitation and a series of continuous wave (CW) multi-frequency excitations. The time-domain pulse excitation may facilitate collocated sensor acquisition during an off cycle or suffice to record non-collocated responses which may electronically be converted into multi-frequency (harmonics) measurements. In some cases, decreased signal-to-noise (S/N) ratios associated with certain frequencies (e.g., higher harmonics) due to an inverse scaling with frequency, may be addressed by the series of CW multi-frequency excitations where each frequency is excited individually to achieve higher (e.g., maximum) S/N ratio. A fundamental frequency of the EM logging tool 26 may be as low as 0.3 Hz that may penetrate as deep as 5 and 6 metallic casings.

In certain embodiments, a total metal loss may be evaluated from a look-up table of measured phase, where a receiver voltage is normalized to a signal from a monitor coil wound around the transmitter 60. The measurements and interpretations described above may be based on remote field eddy current (RFEC) principle, where the phase of an induced signal (e.g., the returning magnetic field 94) is proportional to total casing thickness if the receiver (e.g., receiver 68) is sufficiently far from the transmitter 60.

Some inversion-based methods may be capable of processing the multi-frequency and multi-spacing non-collocated measurements to quantify the individual casing thickness in cases like multiple strings including 2 or 3 nested casings. However, such methods may not be able to evaluate up to 4 and 5 nested casings using the methods and systems described in the present disclosure, such as acquiring and processing time-domain measurements from single or multiple collocated sensors, and acquiring and processing (e.g., using combined workflow) both collocated and non-collocated measurements. In certain embodiments, a Gauss-Newton model-based inversion may be used to evaluate multiple casing thicknesses from time-domain collocated sensors and further using the inverted results in processing deeper multi-frequency multi-spacing non-collocated measurements.

Pulsed eddy current (PEC) evaluation of multiple casings may include using pulsed current source to excite eddy currents in the casings. A primary electromagnetic (EM) field generated by a transmitter coil (e.g., solenoidal coil) may induce the eddy currents in the surrounding casings flowing azimuthally along a specific direction to generate a secondary EM field opposing the excitation field (the primary EM field). The secondary EM field may decay exponentially, therefore generating (e.g., inducing) currents in surrounding casings that are sensed by the receiver coil. In some embodiments, the receiver coil(s) of the one or more collocated receivers 61 may be wound on the same core as the transmitter coil. In some embodiments, the receiver coil(s) of the one or more collocated receivers 61 may be wound on a different core from the transmitter coil.

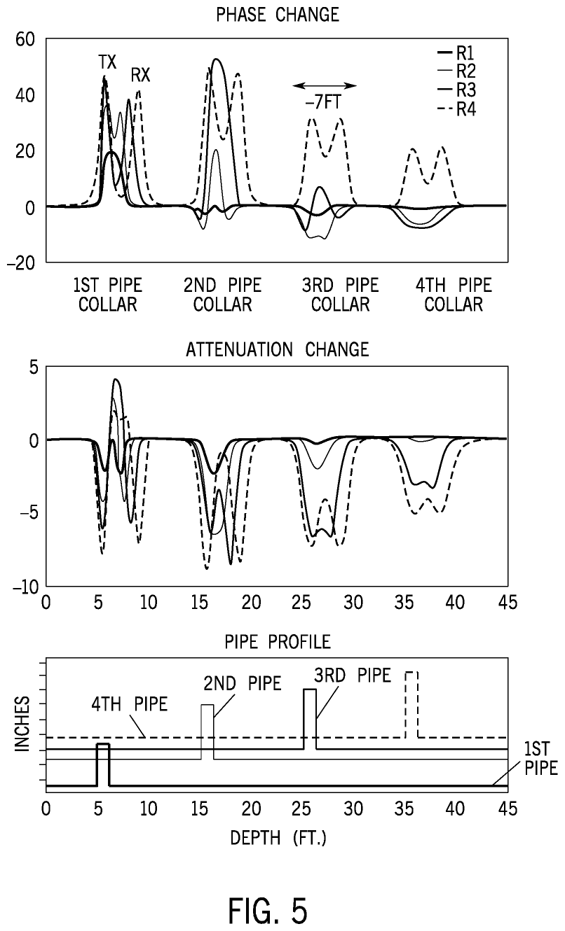

Traditional inversion-based workflows may process the multi-frequency and multi-spacing data obtained at a single depth to quantify the individual casing thickness in multiple strings. However, non-collocation of transmitter(s) and receivers results in double indication of each pipe anomaly (metal loss or collars) as shown in FIG. 5 for pipe collars on four pipes, each 10 feet apart from its inner pipe's collar. In particular, FIG. 5 depicts non-collocated Rx1-4 sensitivities over 40 feet (typical pipe joint length) with each pipe collar 10 feet apart from inner pipe's collar. Non-collocation results in double indication; first, when the transmitter crosses the collar, and second, when the receiver crosses it. In this common scenario, where the collars do not coincide in space, the majority of the log is either the collar signature from the receiver, or a ghost (coming from transmitter crossing). Due to the non-collocated (bimodal) tool transfer function, the same effect is observed in the case of metal losses. The apparent thicknesses-based collar identification and deghosting workflows (e.g., as disclosed in U.S. Pat. No. 9,977,144, which is incorporated by reference in its entirety herein) may help in identifying the regions of collars and fix the responses for RFEC channels. However, due to non-linearity of short spacing responses, the best that can be achieved is flattening the responses in the vicinity of the collars that is error-prone and essentially missing the regions of corrosion in the collars' vicinity. Alternatively, there is no procedure to correct for corrosion losses; one, there is no pattern to exploit as in the case of collar identification and two, non-linearity of short spacing responses cannot be corrected even if a procedure to localize the corrosion losses is used.

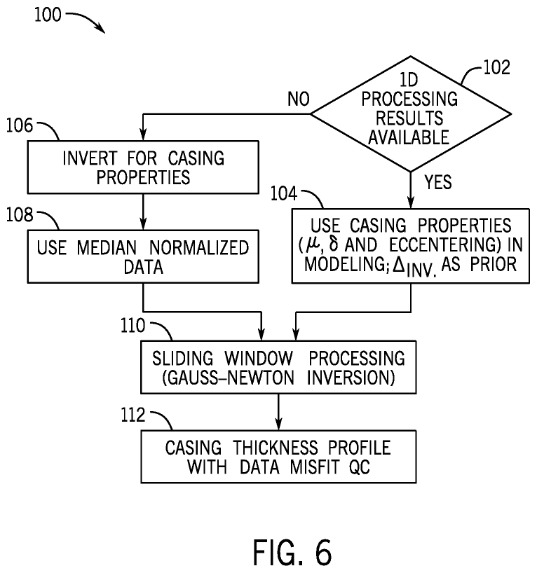

To address these shortcomings of traditional methods, the embodiments described herein provide systems and method to determine a thickness profile of multiple strings from long sections of multi-spacing and multi-frequency measurements, which alleviates the double indication of casing collar and corrosion defects. FIG. 6 summarizes the operations of a profile-based inversion workflow 100. The profile-based inversion workflow 100 begins with a determination of whether one-dimensional (1D) processing results are available (decision block 102). If 1D processing results are available, the casing properties (μ, σ and eccentering) may be used in modeling Δᵢₙᵥ as before (block 104). Conversely, if 1D processing results are not available, the casing properties may be inverted (block 106) and median normalized data from the inversion may be used (block 108). In either event, sliding window processing (e.g., Gauss-Newton inversion) may be performed, as described in greater detail herein (block 110), and a casing thickness profile with data misfit QC may be determined (block 112).

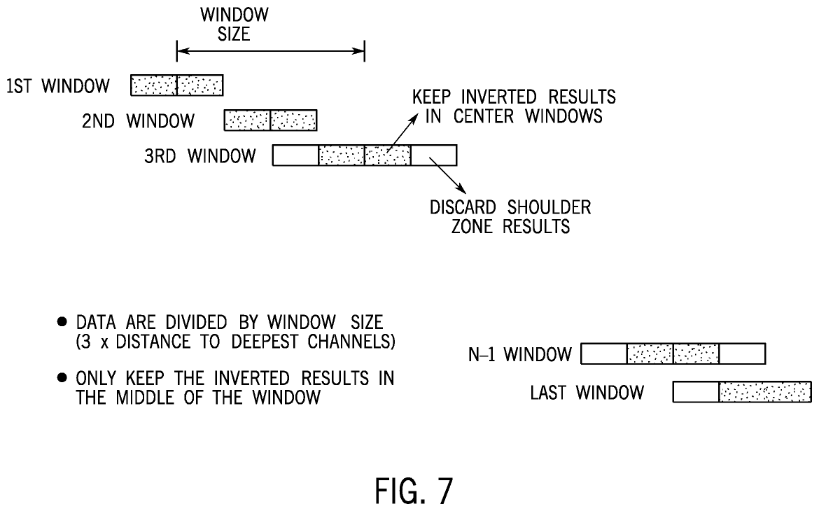

As illustrated in FIG. 7, the measurement interval may be split into N_{win} (number of windows) overlapping (sliding) windows. The size of each window may be selected based on tool spacings (e.g., of EM logging tools 26), typically three times the distance between farthest receivers 62, 64, 66, 68, and 69 from the transmitter 60. The results in the middle section of the window may be saved while those in the shoulders may be discarded. For the second window and beyond, the first quarter of the window keeps the inversion results from the previous window while the inversion parameters in the remaining three quarters are obtained by inverting the complete window data.

In the pre-processing, the total metal thickness log may also be squared or the whole window length may be uniformly discretized to define the pipe thickness sections to be inverted along the length of the processing window. In an N pipe configuration, each section leads to k_{N} unknown thicknesses to be inverted, k is the number of sections in each pipe 22. While the sum of nominal thicknesses may suffice as total metal thickness initial guess, the total metal thickness may also be obtained from the apparent thickness approach using RFEC channel (e.g., as disclosed in U.S. Pat. No. 9,977, 144, which is incorporated by reference in its entirety herein) or from 1D inversion point-by-point processing (e.g., as disclosed in U.S. Pat. No. 9,715,034, which is incorporated by reference in its entirety herein) combined with the de-ghosting.

The measurement data in the processing window may be inverted for the unknown parameters defined in the first operation. The initial guess for these unknown parameters are typically assigned proportional values to each casing 22 in a given section, or preferably from the mean of the 1D results, if 1D inversion results are available. Model-based Gauss-Newton inversion may be used to fit the measurement with the modeled responses. Upon convergence, inversion gives the casing thickness profiles for all the sections to be inverted in the current processing window.

### Gauss Newton Inversion

Inversion minimizes the cost function in terms of difference between the modeled tool response and the actual measurements, sometimes referred as the error term, through adjusting the model, defined by individual casing geometry and properties. The cost function may be augmented with an additional regularization term. The balance between the error and the pixel regularization may be determined heuristically or may be managed by adaptive regularization methods.

The cost function error term is a difference between the modeled tool responses(x) of the unknown model (centered or eccentered casings 22) parameters x and the actual measurements m. In the inversion loop, an axisymmetric finite element-based time-harmonic EM solver may be used. For the error function e(x)=|s(x)−m|, a cost function in a least squares sense may be defined as:

$$C ( x ) = \frac{1}{2} {‖ W \cdot e ( x ) ‖}^{2} + \frac{1}{2} λ {‖ {W}_{x} \cdot ( x - {x}_{ref} ) ‖}^{2} + \frac{1}{2} {λ}_{s} {‖ {W}_{s} \cdot R \cdot x ‖}^{2}$$

where:
W: data weighting matrix, typically as close as possible to the expected standard deviation of corresponding measurement channels W_{d}=diag(1/σᵢ).
Wₓ: parameter weighting matrix of regularization term:
λ regularization constant
Wₛ: weights for the parameter difference
R: parameter difference matrix
λₛ: parameter difference penalization constant

The model parameters x may be obtained by minimization of the cost function:

$${x}^{*} = {min}_{x} [ C ( x ) ]$$

Box constraints may be used to bound model parameters x (xmin≤x≤xmax). For a given parameter set x the cost function is linearized, the cost function is linearized:

$$e ( x + p ) \approx e ( x ) + J ( x ) \cdot p$$

where J(x) is the Jacobian matrix, that contains the first derivatives of the simulated response:

$${( J ( x ) )}_{ij} = \frac{\partial {e}_{i}}{\partial {x}_{j}} ( x ) = \frac{\partial {s}_{i}}{\partial {x}_{j}} ( x )$$

and the step p that decreases the cost function may be determined iteratively until convergence.

The linearized error term may be inserted in the cost function and the linearized cost function may be:

$$C ( x + p ) \approx L ( p ) = C ( x ) + g ( x ) \cdot p + \frac{1}{2} {p}^{T} \cdot H ( x ) \cdot p$$

with the gradient g(x)=J^{T}·W^{T}·W·e(x)+λWₓ^{T}·Wₓ·(x−x_{ref}) and the Hessian matrix

$$H ( x ) = {J}^{T} \cdot {W}^{T} \cdot W \cdot J + λ {{W}_{x}}^{T} \cdot {W}_{x} .$$

The regularization term may be added to the cost function to bias the solution towards x_{ref}. The regularization term may be chosen as the previous step value in order to penalize large changes in parameter values. The regularization constant λ is proportional to squared error term λ=λᵢₙₚᵤₜ∥W·e(x)∥², this decreases the bias of inversion with progression towards global minimum.

If the Huber inversion is used (robust to data outliers and noise), the data error term of the cost function changes to:

$${χ}^{2} = {\sum }_{i} {w}_{i} \cdot φ ( {e}_{i} ( x ) )$$

with the Huber function:

$$φ ( y ) = \{ \begin{matrix}{y}^{2} & \vert y \vert < δ \\ 2 δ ( \vert y \vert - 0.5 δ ) & \vert y \vert > δ\end{matrix}$$

where function y corresponds to a data error (difference between measurement and model) and δ is the threshold where the error calculation switches from squared to linear.

A squared parameter difference penalization leads to smooth transitions between the parameters even if there is a sharp step in the underlying values and the measurement data is sensitive to this step. By contrast, if the absolute parameter difference (L1 norm) is penalized, the penalty of a sharp step is the same as a linear transition. Consequently, this penalization is more desirable when a blocky structure with discrete steps is expected. It is not possible to use the absolute differences of the parameter differences as a penalty because its first derivative is not continuous, but it can be easily approximated by the following function:

$${ϕ}_{s} ( y ) = \vert y \vert \approx \sqrt{{y}^{2} + {c}^{2}} if {c}^{2} ≪ {y}^{2}$$

After inserting the robust error term and the L1-norm parameter differences in the cost function is:

$$C ( x ) = \frac{1}{2} {\sum }_{i} ϕ ( {w}_{i} \cdot {e}_{i} ( x ) ) + \frac{1}{2} λ {‖ {W}_{x} \cdot ( x - {x}_{ref} ) ‖}^{2} + \frac{1}{2} {λ}_{s} {\sum }_{i} {ϕ}_{s} ( {w}_{s , i} {R}_{i} \cdot x )$$

### Model Parameterization

The inversion can resolve any subset of following parameters:
i. casing thickness (thᵢ) of each section
ii. bounds of intervals for each casing defining constant thickness
iii. center (cᵢ) of each casing
iv. permeability (μᵢ) of individual casings or assume all the casings have the same properties
v. conductivity (σᵢ) of individual casings or assume all the casings have the same properties

The standard setting is that metal loss occurs on the outer surface of the pipe 22. The inversion model parameterization also allows inverting for the inner and/or outer diameter of individual casings 22. The functionality is useful in case sufficient information content in the data is available to resolve these parameters, or if some of them are know from some other data, such as ultrasonic measurements.

In standard interpretation the casings 22 may be assumed to be concentric. The typical use of inversion in the workflow is as follows:
i. For measurement calibration: invert for the casing magnetic permeabilities and/or electric conductivities for a known set of casing thicknesses. The nominal casing thickness is typically assumed at multiple measured depths, inverting for casing properties and eccentering;
ii. Discretize the casings 22 as parameters so that the model-based (built from log squaring 1D inversion results or deep (e.g., RFEC in certain embodiments) apparent thicknesses), pixel-based or pixelated-model (hybrid) inversion may be initiated;
iii. Process calibrated data for casing thicknesses, using known determined permeability and conductivity from the calibration step. Processing may be parallel or sequential;
iv. Refined inversion interpretation in combination with other data, such as ultrasonic, collocated pulsed eddy current data or flux leakage data, that may be used to constrain some parameters (first casing inner or outer diameter for ultrasonic/flux leakage, up to first 3 or 4 casing thicknesses from PEC collocated sensors and maybe eccentering);
v. The inversion outputs: data misfit, residual, model covariance and data resolution matrix, may be used for interpretation QC use;
   1. Eccentering indicator from quality of fit of short spacing, in case long spacing data are well reconstructed;
   2. Estimate the parameter uncertainty from the model covariance matrix;
   3. Use data resolution matrix to evaluate the information content in the data-may be used for optimal selection of measurements in the job planner.

### Model-Based Inversion

An initial model for the profile-based casing thickness evaluation may be built by log-squaring:
a. the apparent thickness of the lowest frequency phase/attenuation remote field eddy current (or any available longest spacing receiver) measurement, which corresponds to the total metal thickness (e.g., as disclosed in U.S. Pat. No. 9,977,144, which is incorporated by reference in its entirety herein); or
b. The sum of inverted thicknesses from 1D processing (e.g., as disclosed in U.S. Pat. No. 9,715,034, which is incorporated by reference in its entirety herein).

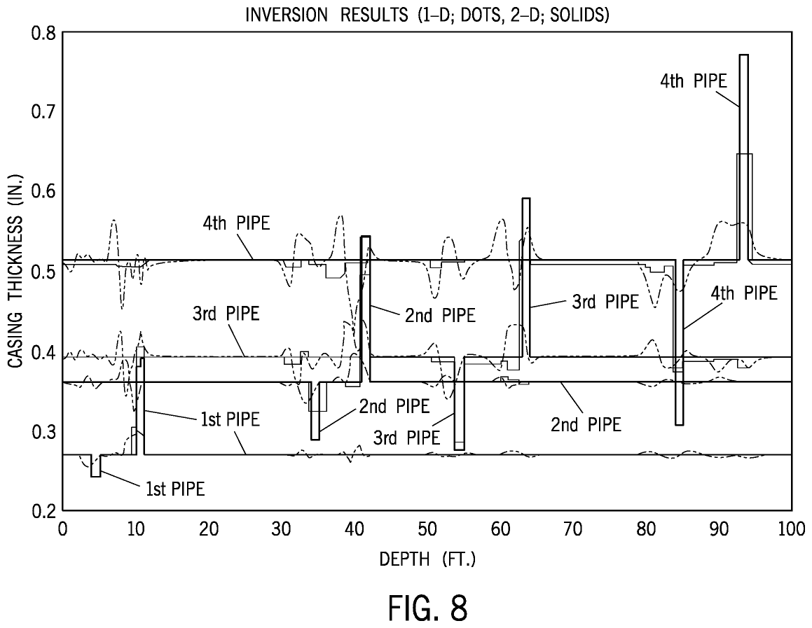

As an example, with a four-casing setting (outer diameters: 4.5″, 7″, 9⅝″, and 13⅜″; nominal thicknesses: 0.271″, 0.362″, 0.395″, 0.43″ for the first, second, third, and fourth pipes 22, respectively; relative permeability, μᵣ=80 and conductivity, σ=5×10⁶ S/m). The synthetic data obtained from a multi-casing inspection tool was generated for the profile shown in FIG. 8. The dotted lines represent the 1D results and the associated solid lines represent the 2D results where the flat straight lines represent true values.

There is an axisymmetric 1 foot long corrosion defect on first, second, third, and fourth pipe 22, respectively, at 4-5 feet (10% loss), 34-35 feet (20% loss), 54-55 feet (30% loss), and 84-85 feet (40% loss). A collar 24 on each pipe 22 is modeled as 1 foot long and 50% extra metal centered at 11.5 feet, 41.5 feet, 63.5 feet, and 93.5 feet for first, second, third, and fourth pipes 22, respectively. The edge-to-edge distance between collars 24 and defects are 6, 7, 9, and 9 feet, respectively, for this example.

The total metal thickness log may be squared to define the sections of pipes 22 to be inverted. In this example, the total metal thickness may be obtained from processing the log in a point-by-point 1D inversion (e.g., as disclosed in U.S. Pat. No. 9,715,034, which is incorporated by reference in its entirety herein). The initial guess for these unknown parameters may be obtained by taking mean of the 1D results for each casing 22 in a given section.

The model-based non-linear Gauss-Newton inversion may be used to fit the measurement data with the modeled responses. The inversion results for this example are shown in FIG. 8. For comparison purposes, the true values and results from 1D inversion are also presented. It is evident that the proposed method agrees very well with the true values and the “ghost” effects present in 1D inversion are totally removed in the proposed profile-based inversion results.

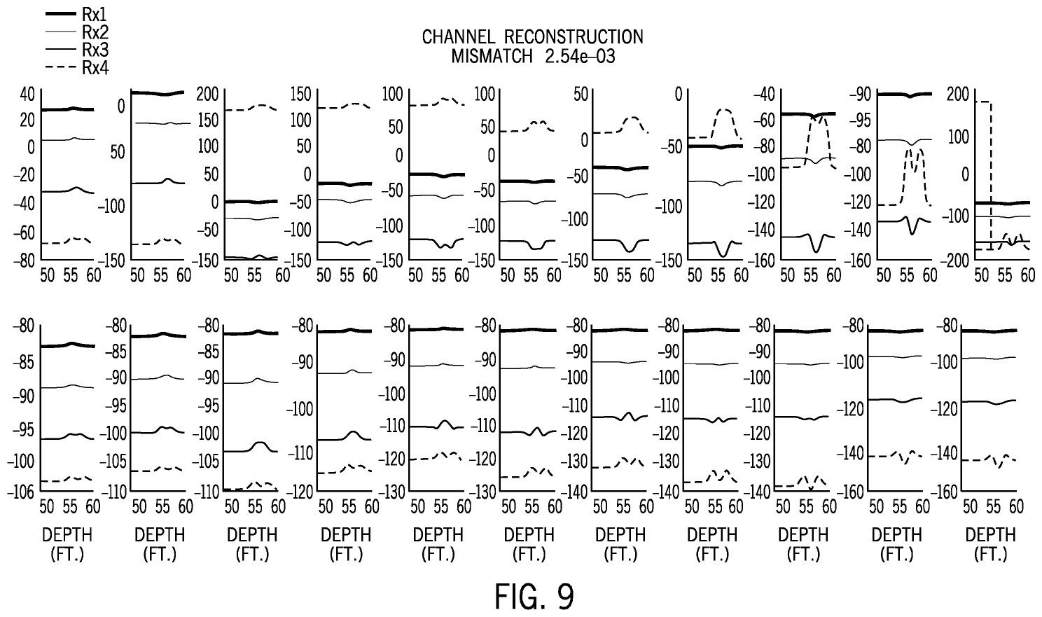

The data reconstruction in the 9th processing window is shown in FIG. 9 for first ten frequency modes. The inversion was able to fully reconstruct the original data. Quantitatively, it results in a data mismatch of 2.54×10⁻³ (i.e., the ratio of the difference between the data and modeled responses is 0.254% of the measured data).

### Pixel-Based Approach

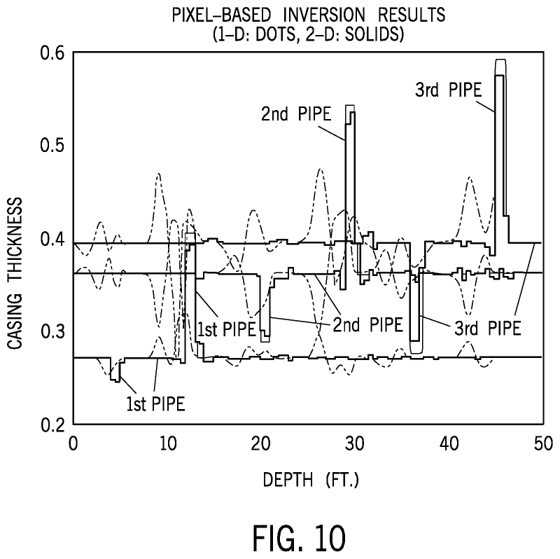

In another embodiment, instead of inverting for thickness of intervals determined by the squaring of apparent thickness, the casing 22 may be discretized into pixels, short sections of the same length below the resolution of the measurements, and invert for thickness only with the help of adaptive L1 gradient regularization, similarly to the methodology for directional resistivity imaging. FIG. 10 shows the three-casing (OD: 4.5″, 7″, and 9⅝″ for the first, second, and third pipes 22, respectively) results obtained from pixel-based profile processing of synthetic data. As evident, the inverted profile (the solid lines) matches the true (the dotted lines) profile and the artefacts from 1D processing are completely removed.

### Hybrid (Pixelated Model-Based) Approach

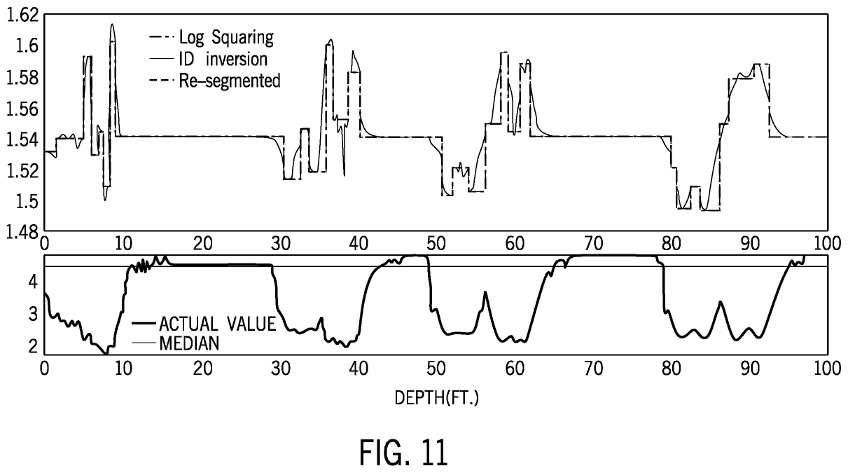

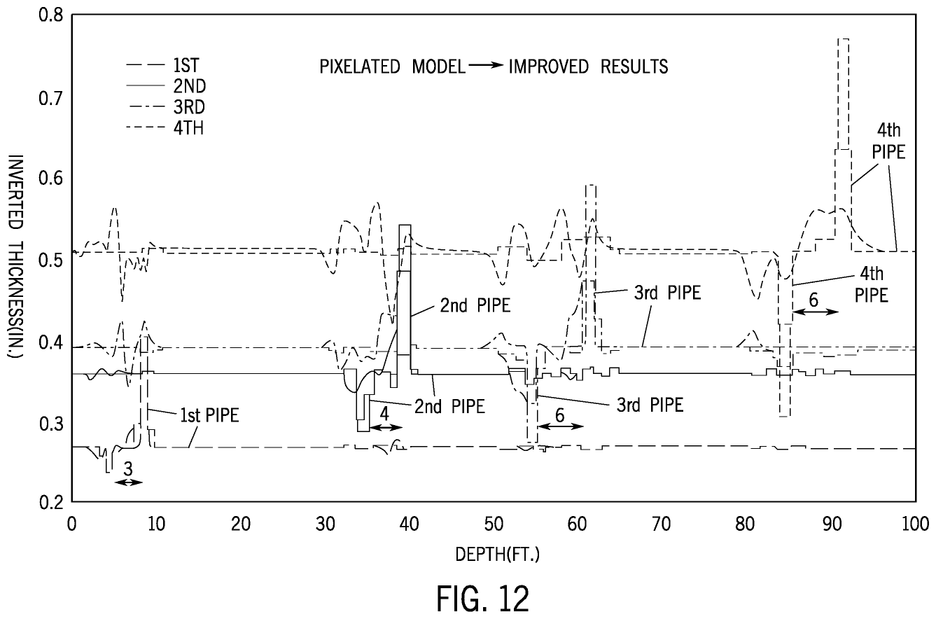

In another embodiment, if 1D inversion results are present, a hybrid (pixelated model-based) discretization may be used that exploits prior model (1D inverted thicknesses) knowledge to significantly improve accuracy and processing speed for up to 5- and 6-casing 22 scenarios. The prior model supplies extra information guiding the inversion to ensure vertical resolution is physically constrained, by log squaring, in low-misfit sections and finely captured, by pixels, in high-misfit sections. FIG. 11 shows the procedure followed to re-segment the original log-squaring results based on the quality of 1D data reconstruction. For poor quality fits, the original log squared segment is partitioned into smaller (e.g., in this case 1 foot long) segments so as to properly capture the features missed by 1D processing in the profile-based processing. FIG. 12 shows the processing results for such a hybrid model which are of far superior quality even though the defects are closer (3, 4, 6, and 6 feet, respectively, for first, second, third, and fourth casings 22, respectively) to collars 24 than previous examples and, hence, present higher ambiguity and challenge in resolving them.

### Processing Eccentered Casings Data

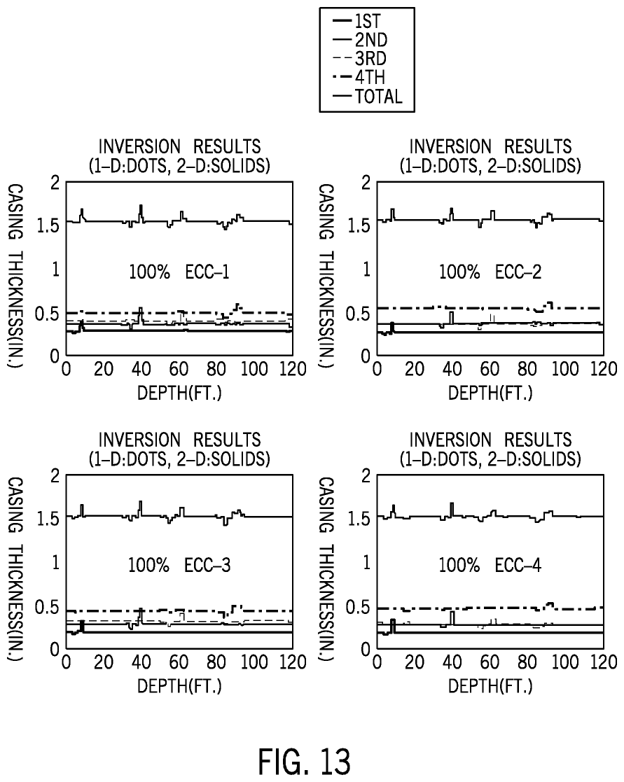

Similarly, when the eccentering of the casings 22 is already inverted during 1D processing, it can be employed in the forward modeling responses running inside the inversion loop to reconstruct the measured data. FIG. 13 shows results for the same true profile but in terms of four different cases, each having 100% eccentered first, second, third or fourth pipe 22, respectively. The data from fully eccentered pipes 22 is first inverted using 1D processing (e.g., as disclosed in U.S. Pat. No. 9,715,034, which is incorporated by reference in its entirety herein) to get inverted thicknesses, pipe properties and eccentering, which are then utilized in the profile-based processing. The resulting profiles match with the true profiles in FIG. 11, showing the versatility and capabilities of the processing. In case 1D results are not available for eccentering, the processing may be used to invert for the eccentering parameter or instead use a locally normalized responses (V/V_{med}) where V_{med} is the response obtained from median filtering data over one to three pipe joints. Such a normalization corrects for the eccentering effects to the first order and concentrates on the local variations from pipe anomalies (collars and defects).

### Multi-Pass Parallelized Processing

In a parallelized sliding window implementation, all the windows may be inverted independently. For the 1^{st} quarter of the n^{th} window in a p^{th} pass, the (p-1)^{th} pass results from the (n-1)^{th} window are fixed and, again, the complete window data may be inverted for the parameters in the remaining window quarters. It has been observed that the inversion results usually converge in 3 passes. If Nₚₐₛₛ is the number of passes, the speed-up from parallel processing is N_{win}/Nₚₐₛₛ.

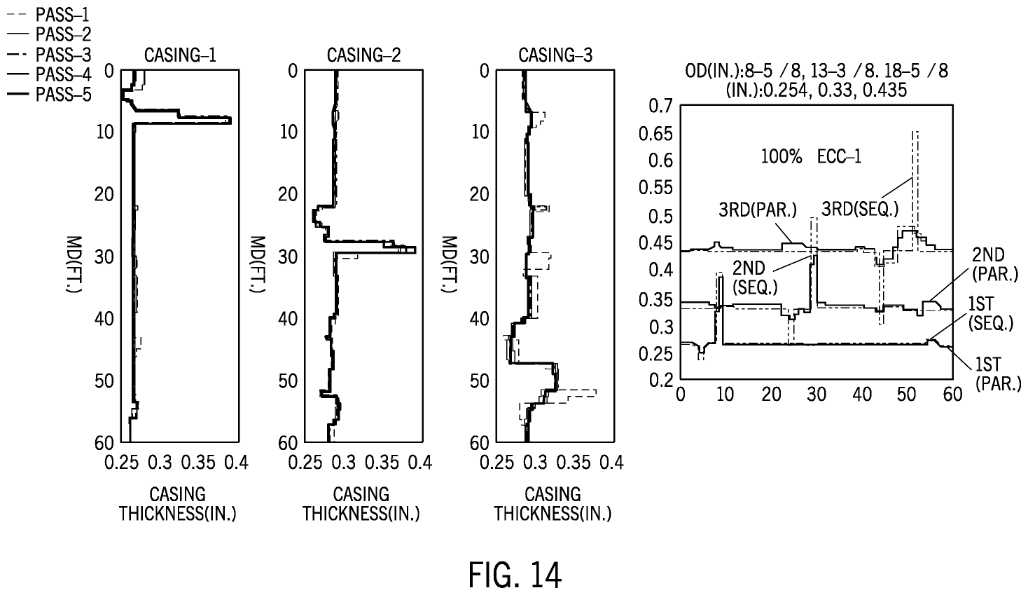

FIG. 14 shows the comparison of sequential and multi-pass parallelized sliding window processing results from inverting data for three casings 22 (OD: 8-5/8″, 13⅜″, and 18⅝″; and Δₙₒₘ: 0.264″, 0.33″, and 0.435″ for the first, second, third, and fourth casings 22, respectively) where the first casing 22 is maximally eccentered with respect to the tool axis. Again, 1 foot long defects are placed in the vicinity of each casing's collars 24; 10%, 20%, and 30%, respectively, for first, second, and third pipes 22, respectively. For this case, the 1D eccentering-thickness inversion results are available, thus, eccentering correction may be applied to the raw measurements and a pixelated-model hybrid discretization of the casings 22 may be applied for processing. It is shown that even after the second pass, the results converge to the results obtained after the fifth pass. Typically, Nₚₐₛₛ=3 is used. As shown, due to the large size of the first pipe 22, the vertical resolution of the inverted results is not as precise, but the overall location and accumulative losses over the diffused lengths are well reconstructed for both sequential and parallel processing. The solid lines for each casing 22 are with parallel processing and the dotted lines for each casing 22 are with sequential processing.

### Post-Processing Inversion Results

A data resolution matrix is defined in terms of sensitivities (Jacobian matrix, J) and it has to include the data weight and the regularization terms used in the inversion.

$$\hat{m} = {R}^{data} \cdot {m}^{obs} = {J [ {J}^{T} {W}^{T} WJ + λ {W}_{x}^{T} {W}_{x} ]}^{- 1} {J}^{T} {W}^{T} W \cdot {m}^{obs} .$$

The symmetrized version of R_{data} may be used to analyze off-diagonal elements of R_{data} and the dependence of one reconstructed data point on all the other data points,

$${R}_{sym}^{data} = {WJ [ {J}^{T} {W}^{T} WJ + λ {W}_{x}^{T} {W}_{x} ]}^{- 1} {J}^{T} {W}^{T} .$$

The uncertainty in the inverted parameters may be expressed in the form of the Hessian matrix.

$$H = [ {J}^{T} {W}^{T} WJ + λ {W}_{x}^{T} {W}_{x} ] .$$

Since this matrix comes as a byproduct of the inversion scheme, and the data error term, χ2 is evaluated, the mathematical uncertainty (σⱼ) in the j^{th} inverted parameter may be given by:

$${σ}_{j} = \sqrt{{{χ}^{2} [ {H}^{- 1} ]}_{j , j}}$$

Similarly, correlation of the inverted parameters i and j may be obtained from normalized off-diagonal elements of the inverted Hessian matrix.

$${[ {C}_{x} ]}_{i , j} = {[ {H}^{- 1} ]}_{i , j} / \sqrt{{{[ {H}^{- 1} ]}_{i , j} [ {H}^{- 1} ]}_{j , j}}$$

As such, the embodiments described herein are configured to perform a method to determine a thickness profile of nested metallic casings 22 (e.g., utilizing the data processing system 38 and/or a similar data processing system of an EM logging tool 26). In certain embodiments, the method may include processing induction multi-spacing and multi-frequency non-collocated sensor data (e.g., attenuation data and phase data) measured by the EM logging tool 26 disposed proximate a plurality of nested metallic casings 22; using an inversion-based process to deconvolve a tool transfer function from a surrounding casing structure and its anomalies by running an axisymmetric modeling solver with a model in an inversion loop; and determining a thickness profile of the plurality of nested metallic casings 22 based at least in part on the deconvolved tool transfer function.

In addition, in certain embodiments, the method may further include using a sliding window-based inversion process to determine the thickness profile of the plurality of nested metallic casings 22 in each window of a plurality of windows using a sequential or parallel algorithm. In such embodiments, the method may further include determining an effective total thickness; and log-squaring the effective total thickness to define a number of sections of each metallic casing 22 of the plurality of nested metallic casings 22 to be processed in each window of the plurality of windows and an initial guess for inversion by slightly adjusting a casing thickness for each metallic casing 22 of the plurality of nested metallic casings 22.

In addition, in certain embodiments, the method may further include performing an inversion-based measurement calibration to determine: pipe effective permeability and/or conductivity for each metallic casing 22 of the plurality of nested metallic casings 22; and calibration shifts for a plurality of measurement channels. In such embodiments, the inversion-based measurement calibration may be performed over multiple log sections of data or on a single representative section of data showing minimal perturbation.

In addition, in certain embodiments, the model may include eccentering parameters to correct for eccenterings of the plurality of nested metallic casings 22 and/or the EM logging tool 26. In such embodiments, the eccentering parameters may be obtained from one-dimensional (1D) inversion. In addition, in certain embodiments, the method may further include normalizing the sensor data with respect to median filtered data. In such embodiments, processing the sensor data may include processing the normalized sensor data.

In addition, in certain embodiments, the method may operate on uniform pixilation for unbiased inversion as well as non-uniform pixilation (using information from apparent thicknesses or 1D results or mismatch) and model-based (log-squaring of apparent thicknesses or 1D inverted thicknesses) discretization with different level of resolution. In addition, in certain embodiments, the method may incorporate inner pipe thickness results from other physics as well (e.g., ultrasonics, magnetic flux leakage, or photoelectrochemical (PEC) collocated sensors) giving improved results for outer pipes 22.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

1. A method to determine a thickness profile of nested metallic casings; comprising:
processing induction multi-spacing and multi-frequency non-collocated sensor data measured by a downhole well tool disposed proximate a plurality of nested metallic casings, wherein the sensor data is received from one or more transmitters and one or more receivers oriented arbitrarily in space;
using an inversion-based process to deconvolve a tool transfer function from a surrounding casing structure and its anomalies by running an axisymmetric modeling solver with a model in an inversion loop;
determining a thickness profile of the plurality of nested metallic casings based at least in part on the deconvolved tool transfer function; and
using a sliding window-based inversion process to determine the thickness profile of the plurality of nested metallic casings in each window of a plurality of windows using a sequential or parallel algorithm.

2. (canceled)

3. The method of claim 1, further comprising:
determining an effective total thickness; and
log-squaring the effective total thickness to define a number of sections of each metallic casing of the plurality of nested metallic casings to be processed in each window of the plurality of windows and an initial guess for inversion by slightly adjusting a casing thickness for each metallic casing of the plurality of nested metallic casings.

4. The method of claim 1, wherein the sensor data comprises attenuation data and phase data.

5. The method of claim 1, further comprising performing an inversion-based measurement calibration to determine:
pipe effective permeability and/or conductivity for each metallic casing of the plurality of nested metallic casings; and
calibration shifts for a plurality of measurement channels.

6. The method of claim 5, wherein the inversion-based measurement calibration is performed over multiple log sections of data.

7. The method of claim 5, wherein the inversion-based measurement calibration is performed on a single representative section of data showing minimal perturbation.

8. The method of claim 1, wherein the model comprises eccentering parameters to correct for eccenterings of the plurality of nested metallic casings and/or the downhole well tool.

9. The method of claim 8, wherein the eccentering parameters are obtained from one-dimensional (1D) inversion.

10. The method of claim 1, further comprising normalizing the sensor data with respect to median filtered data, and wherein processing the sensor data comprises processing the normalized sensor data.

11. A tangible computer-readable medium comprising computer instructions that, when executed by at least on processor, cause the at least one processor to:
process induction multi-spacing and multi-frequency non-collocated sensor data measured by a downhole well tool disposed proximate a plurality of nested metallic casings, wherein the sensor data is received from one or more transmitters and one or more receivers oriented arbitrarily in space;
use an inversion-based process to deconvolve a tool transfer function from a surrounding casing structure and its anomalies by running an axisymmetric modeling solver with a model in an inversion loop;
determine a thickness profile of the plurality of nested metallic casings based at least in part on the deconvolved tool transfer function; and
use a sliding window-based inversion process to determine the thickness profile of the plurality of nested metallic casings in each window of a plurality of windows using a sequential or parallel algorithm.

12. (canceled)

13. The tangible computer-readable medium of claim 11, wherein the computer instructions, when executed by the at least one processor, further cause the at least one processor to:
determine an effective total thickness; and
log-square the effective total thickness to define a number of sections of each metallic casing of the plurality of nested metallic casings to be processed in each window of the plurality of windows and an initial guess for inversion by slightly adjusting a casing thickness for each metallic casing of the plurality of nested metallic casings.

14. The tangible computer-readable medium of claim 11, wherein the computer instructions, when executed by the at least one processor, further cause the at least one processor to perform an inversion-based measurement calibration to determine:
pipe effective permeability and/or conductivity for each metallic casing of the plurality of nested metallic casings; and
calibration shifts for a plurality of measurement channels.

15. The tangible computer-readable medium of claim 14, wherein the inversion-based measurement calibration is performed over multiple log sections of data.

16. The tangible computer-readable medium of claim 14, wherein the inversion-based measurement calibration is performed on a single representative section of data showing minimal perturbation. cm 17. The tangible computer-readable medium of claim 11, wherein the model comprises eccentering parameters to correct for eccenterings of the plurality of nested metallic casings and/or the downhole well tool.

18. The tangible computer-readable medium of claim 17, wherein the eccentering parameters are obtained from one-dimensional (1D) inversion.

19. The tangible computer-readable medium of claim 11, wherein the computer instructions, when executed by the at least one processor, further cause the at least one processor to normalize the sensor data with respect to median filtered data, and wherein processing the sensor data comprises processing the normalized sensor data.

20. (canceled)
